(19) United States
(12) Patent Application Publication
(10) Pub. No.: US 2015/0363340 A1
(43) Pub. Date: Dec. 17, 2015

(54) PROVIDING MULTIPLE SYNCHRONOUS SERIAL CONSOLE SESSIONS USING DATA BUFFERING

(71) Applicant: Microsoft Corporation, Redmond, WA (US)

(72) Inventors: Bryan David Kelly, Redmond, WA (US); Badriddine Khessib, Redmond, WA (US)

(21) Appl. No.: 14/499,732

(22) Filed: Sep. 29, 2014

Related U.S. Application Data
(60) Provisional application No. 62/010,949, filed on Jun. 11, 2014.

(51) Int. Cl. G06F 13/10; G06F 13/20

(52) U.S. Cl. CPC G06F 13/102; G06F 13/20

(57) ABSTRACT

Embodiments are directed to providing synchronous communication between a baseboard management controller (BMC) and a serial console using data buffering, and to providing multiple synchronous serial console sessions using data buffering. In one scenario, a computer system polls a server console for server console data and receives server console data from the server console. The computer system buffers at least a portion of the received server console data in a data store, receives a request for the buffered server console data from a specified entity, and providing the requested buffered server console data to the specified entity. Optionally, the computer system may also receive encapsulated data from a chassis management application, unencapsulate the received encapsulated data, and send the unencapsulated data to the server console.

### CROSS-REFERENCE TO RELATED APPLICATIONS

This application claims priority to and the benefit of U.S. Provisional Application Ser. No. 62/010,949, entitled “Providing Multiple Synchronous Serial Console Sessions Using Data Buffering”, filed on Jun. 11, 2014, which application is incorporated by reference herein in its entirety.

### BACKGROUND

Data centers are used all over the world to provide massive amounts of processing and storage capacity. Data centers typically include multiple racks of servers which are often referred to as “blades”. These blades each include one or more processors, memory and potentially storage. The blade motherboards also come equipped with a baseboard management controller (BMC) which monitors server operating parameters such as temperature, cooling fan speed, power status, operating system status, etc. The BMC interfaces with other blade components (including hardware and software components such as a chassis management interface) according to the Intelligent Platform Management Interface (IPMI).

### BRIEF SUMMARY

Embodiments described herein are directed to providing synchronous communication between a baseboard management controller (BMC) and a serial console using data buffering and to providing multiple synchronous serial console sessions using data buffering. In one embodiment, a computer system polls a server console for server console data and receives server console data from the server console. The computer system buffers at least a portion of the received server console data in a data store, receives a request for the buffered server console data from a specified entity, and providing the requested buffered server console data to the specified entity. Optionally, the computer system may also receive encapsulated data from a chassis management application, unencapsulate the received encapsulated data, and send the unencapsulated data to the server console.

In another embodiment, a computer system provides multiple synchronous serial console sessions using data buffering. A chassis management application or remote host receives a request for serial console data. The chassis management application or remote host is configured to conduct multiple serial console sessions simultaneously by buffering data received from a serial console. The chassis management application or remote host initiates a serial session between a BMC and the serial console, where the serial session includes data requests and responses sent between the BMC and the serial console, and where the BMC stores each serial console response in a data store. The chassis management application or remote host initiates a second serial session between the BMC and the serial console and simultaneously manages the second serial session between the BMC and the serial console, where the second serial session includes data requests and responses sent between the BMC and the serial console. The BMC is configured to store each serial console response in the data store upon receipt of the response.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including providing synchronous communication between a baseboard management controller (BMC) and a serial console using data buffering.

FIG. 2 illustrates a flowchart of an example method for providing synchronous communication between a BMC and a serial console using data buffering.

FIG. 3 illustrates a flowchart of an example method for providing multiple synchronous serial console sessions using data buffering.

FIG. 4 illustrates a computer architecture in which embodiments described herein may operate including providing multiple synchronous serial console sessions using data buffering.

FIG. 5 illustrates an embodiment in which multiple synchronous serial console sessions are provided using data buffering.

### DETAILED DESCRIPTION

Embodiments described herein are directed to providing synchronous communication between a baseboard management controller (BMC) and a serial console using data buffering and to providing multiple synchronous serial console sessions using data buffering. In one embodiment, a computer system polls a server console for server console data and receives server console data from the server console. The computer system buffers at least a portion of the received server console data in a data store, receives a request for the buffered server console data from a specified entity, and providing the requested buffered server console data to the specified entity. Optionally, the computer system may also receive encapsulated data from a chassis management application, unencapsulate the received encapsulated data, and send the unencapsulated data to the server console.

In another embodiment, a computer system provides multiple synchronous serial console sessions using data buffering. A chassis management application or remote host receives a request for serial console data. The chassis management application or remote host is configured to conduct multiple serial console sessions simultaneously by buffering data received from a serial console. The chassis management application or remote host initiates a serial session between a BMC and the serial console, where the serial session includes data requests and responses sent between the BMC and the serial console, and where the BMC stores each serial console response in a data store. The chassis management application or remote host initiates a second serial session between the BMC and the serial console and simultaneously manages the second serial session between the BMC and the serial console, where the second serial session includes data requests and responses sent between the BMC and the serial console. The BMC is configured to store each serial console response in the data store upon receipt of the response.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

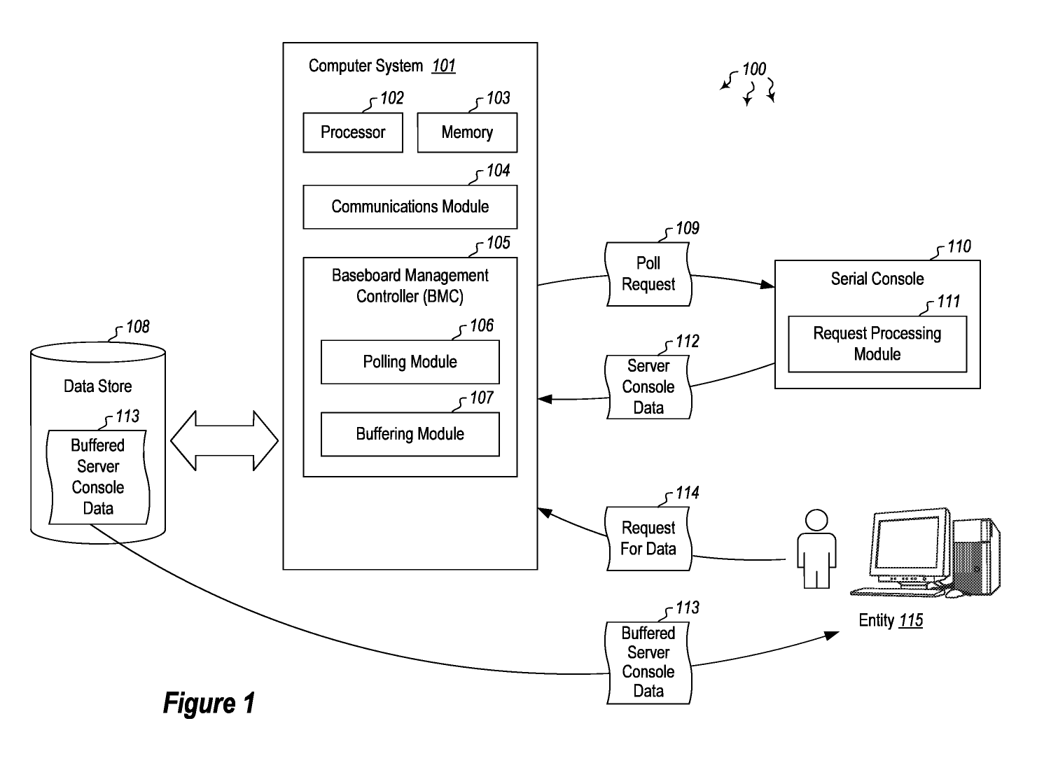

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The computing module 104 may include any wired or wireless communication means that can receive and/or transmit data to or from other computing systems. The communications module 104 may be configured to interact with databases, mobile computing devices (such as mobile phones or tablets), embedded or other types of computing systems.

The computer system 101 may further include a baseboard management controller (BMC) 105. BMCs may be installed on various types of computing systems including server computing systems. In one embodiment, the computer system 101 comprises one or more server blades. Each of these server blades may be configured to communicate with serial consoles (e.g. 110) and with other applications such as chassis manager applications. Chassis manager applications may request serial console data which is buffered by the BMC and provided to the chassis manager upon request (or automatically if so implemented). The chassis manager application may be a management application for managing a rack of servers or a certain subset of servers in a data center.

In some cases, in order for the chassis manager to communicate with a serial console 110 through the BMC 105, a switch is used. Implementation of the switch may introduce delays of up to 15 seconds. In traditional implementations, only one simultaneous serial console session can be active at any one time. During that time, Intelligent Platform Management Interface (IPMI) commands to other server blades or other computing systems would be suspended, internal blade polling would be halted and fan speed would be increased to compensate for temperature excursions.

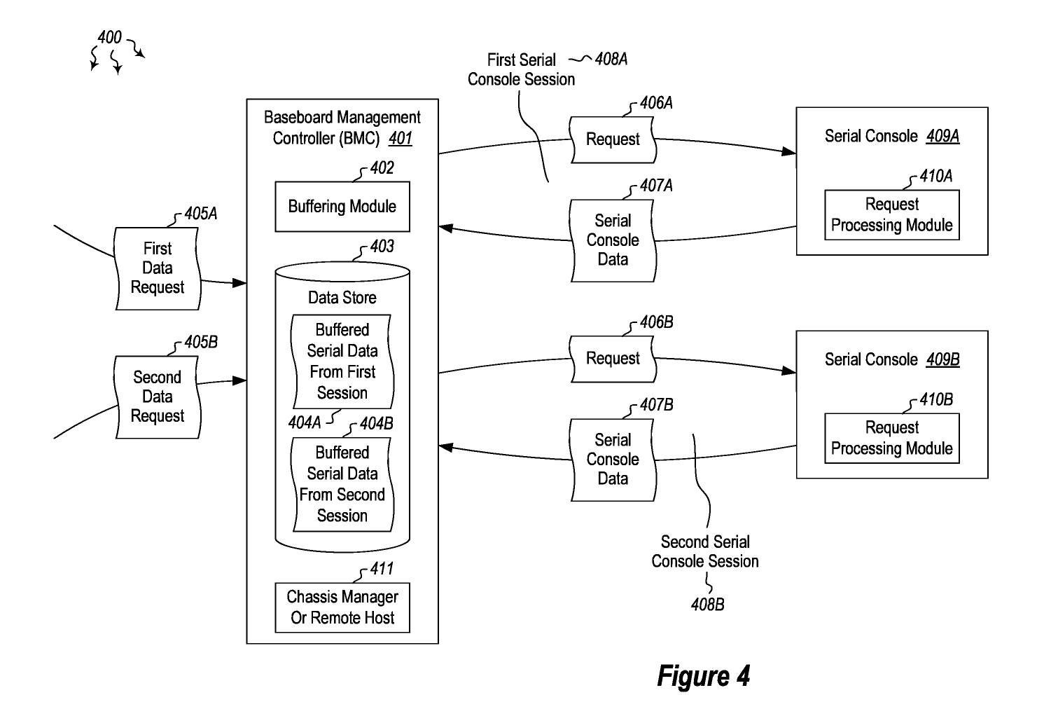

Embodiments described herein change the functionality of the baseboard management controller to implement a request/response mechanism, encapsulating serial console payload over a serial data transfer. Console data 112 may be buffered in buffering module 107 of the BMC 105, allowing the chassis manager (or the polling module 106 or another software application) to poll for the serial data. This allows multiple simultaneous, synchronous (blade) serial console sessions to be instantiated, with the BMC acting as a buffer for polled serial data (this is shown generally in FIG. 4). As referred to here, a serial console 110 provides an interface for a plurality of blade servers. The BMC 105 can communicate with the serial console 110 to determine current operating conditions including temperature, operating system status, etc. The BMC may be configured to read and buffer serial console output. As such, the BMC can act as a caching buffer between the chassis manager (or other software program or entity) and the serial console output, encapsulating console I/O data as serial IPMI messages.

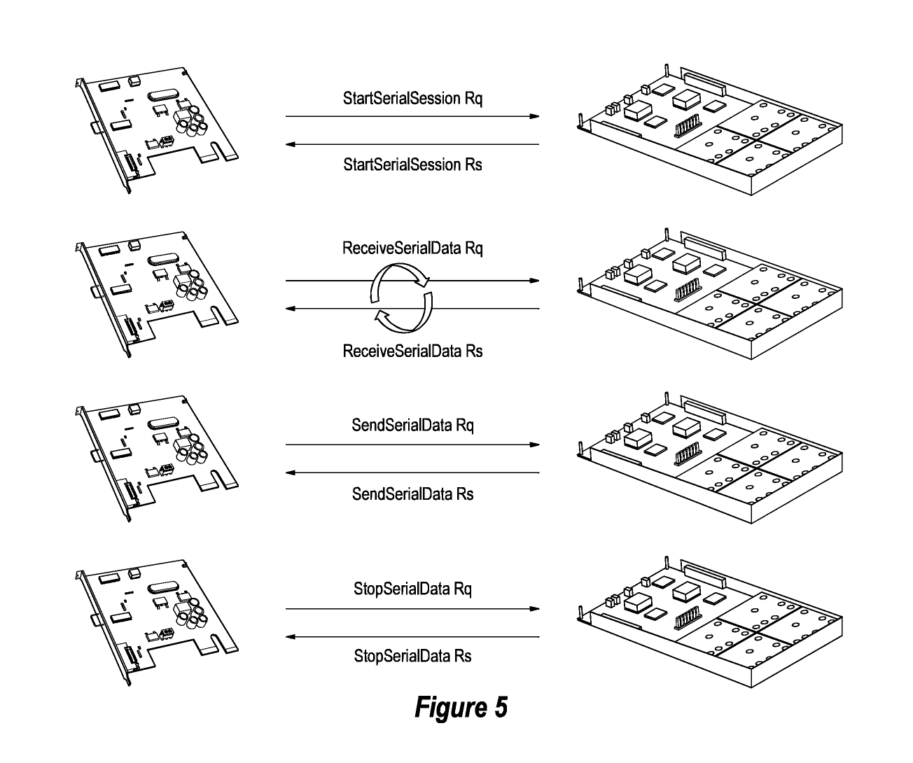

In some embodiments, as shown in FIG. 5, four IPMI commands may be defined: “StartSerialSession” which instructs the BMC to start polling the system console serial port and buffering the serial console data, “ReceiveSerialData” which reads the serial console data from the BMC buffer in response to the chassis manager sending requests in a loop. The BMC may encapsulate the serial console buffer into an IPMI response command, flush the buffer and send the response to the chassis manager.

The “SendSerialData” command may be used by the BMC to extract the encapsulated serial console data from the IPMI message and write data to the serial port. The “StopSerialSession” command may be used by the BMC to stop the BMC polling thread activated by the StartSerialSession command. To obtain a serial console session, the chassis manager issues the StartSerialSession IPMI command. The BMC starts a thread to read serial console data and copy the data into an internal buffer or other data store. At least in some embodiments, the chassis manager (or other application) will continually send the ReceiveSerialData command to the BMC, and the BMC will encapsulate the internal serial console buffer into an IPMI response message, sending the response to the chassis manager.

When the chassis manager interacts with the blade serial console 110, the chassis manager may execute the SendSerialData command to the BMC, and the BMC may then strip the IPMI message framing from the message and forward the data to the system console serial port (i.e. the serial console). The BMC's forwarding of SendSerialData does not block the ReceiveSerialData thread and, as such, at least in some embodiments, separate processing threads may be used. When the chassis manager wishes to stop collecting serial console data, it will send the StopSerialSession to the BMC 105. The BMC will then stop polling and buffering the system console serial port. The StartSerialSession command includes a timeout parameter to inform the BMC to automatically stop the system console serial port polling thread if no ReceiveSerialData or SendSerialData commands have been sent by the chassis manager for at least a specified amount of time. The StartSerialSession command may also include a flush buffer command, which informs the BMC to flush the internal serial console data buffer before starting the thread to poll the BMC. During the serial console session, the BMC can receive and act upon standard IPMI messages.

In one embodiment, a method is described for providing synchronous communication between a BMC and a serial console using data buffering. In the embodiment, a BMC (or other type of computing system) is configured to poll a server console for server console data, receive server console data from a server console, buffer the received console data in a data store, receive a request for the buffered console data from a specified entity and provide the buffered console data to the specified entity. The BMC may begin the polling in response to receiving an indication to begin polling for server console data. This indication may be received from a chassis manager application or from another application or entity.

As mentioned above, the buffered console data may further be encapsulated into a standardized response message prior to being provided to the specified entity 115. The buffered console data may, for example, be encapsulated into an Intelligent Platform Management Interface (IPMI) response message that is sent back to the chassis manager. The chassis manager itself may send encapsulated data to the BMC 105. The BMC then may be configured to unencapsulate the received encapsulated data and send the unencapsulated data to the server serial console 110.

In another embodiment, a method is described for providing multiple synchronous serial console sessions using data buffering. In this embodiment, a BMC (or other type of processor or controller) may be configured to receive a first request for serial console data, where the BMC is configured to conduct multiple serial console sessions simultaneously by buffering data received from a serial console. The BMC initiates a first serial session between the BMC and the serial console, where the first serial session includes data requests and responses sent between the BMC and the serial console, where the BMC stores each serial console response in a data store. The BMC further receives a second request for serial console data at the BMC, and simultaneously initiates a second serial session between the BMC and the serial console, where the second serial session includes data requests and responses sent between the BMC and the serial console, where the BMC stores each serial console response in the data store.

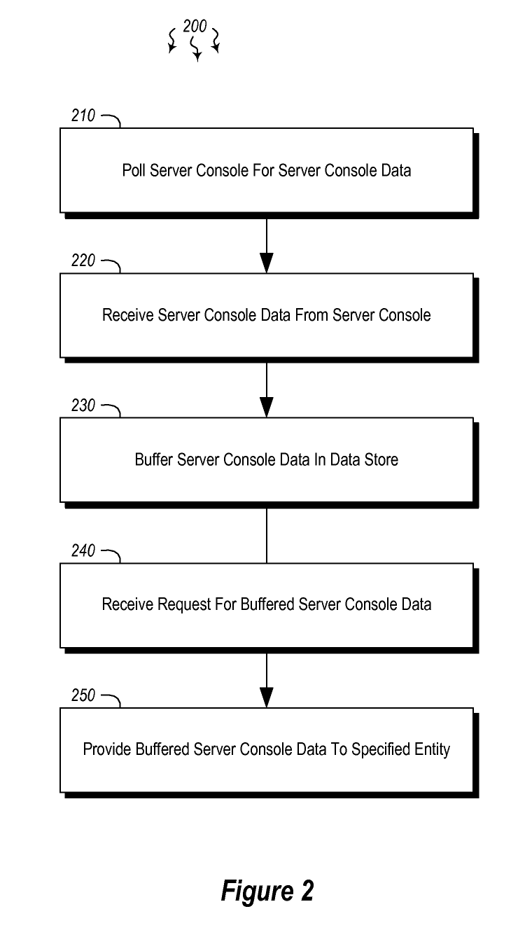

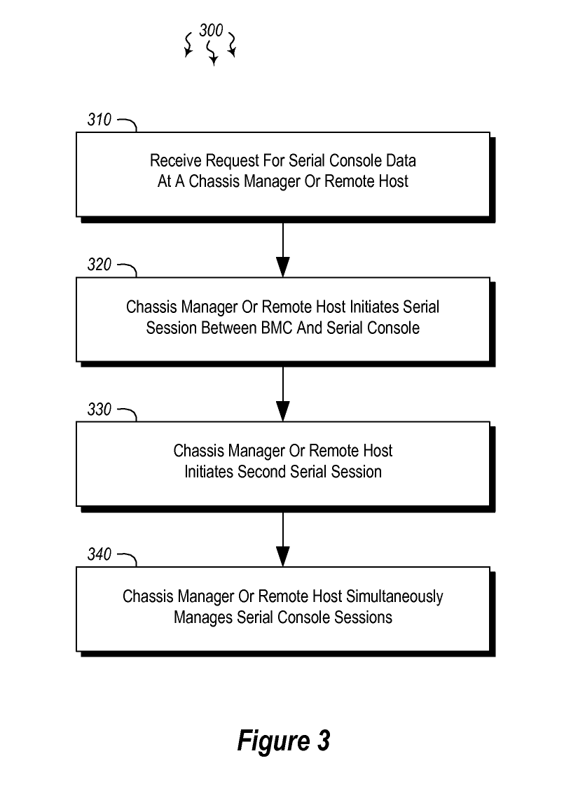

At least in some embodiments, the first serial session remains open until a specified timeout time has been reached. The data store continues to store serial console data until a specified amount of serial console data has been stored. It should also be noted that serial console data that is determined to be beyond the specified amount may be purged from the data store within or accessible by the BMC. The BMC may further encapsulate the stored serial console responses in a specified data wrapper and send the encapsulated serial console responses to a chassis management software application or other application or entity. As mentioned above, the specified data wrapper may be an IPMI wrapper or other type of data wrapper. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for providing synchronous communication between a baseboard management controller (BMC) and a serial console using data buffering. The method 200 will now be described with frequent reference to the components and data of environment 100.

Method 200 includes an act of polling a server console for server console data (act 210). For example, polling module 106 of computer system 101 may poll server console 110 (or “serial console 110” or “serial server console 110” herein) using poll request 109. The polling module 106 may be part of or may itself be an application such as a chassis management application which manages racks of servers or subsets of servers in a data center. The poll request may request information from the server console 110 such as current number of operations being performed, current temperatures, fan speeds, or other operating data. The polling module 106 may be configured to automatically send poll requests 109 at certain intervals. The request processing module 111 of the server console 110 may process the poll requests and send server console data 112 in response.

Method 200 next includes an act of receiving one or more portions of server console data from the server console (act 220), an act of buffering at least a portion of the received server console data in a data store (act 230), and an act of receiving a request for at least a specified portion of the buffered server console data from a specified entity (act 240). Method 200 further includes an act of providing the requested portion of buffered server console data to the specified entity (act 250).

The communications module 104 of computer system 101 may receive the server console data 112 from the server console 110. The buffering module 107 of computer system 101 may buffer the received server console data 112 in data store 108. The data store 108, while shown as being external to computer system 101, may also be internal to computer system 101. Indeed, the data store 108 may be any type of local or remote, singular or distributed data store including a storage area network (SAN) or cloud-based data store. The data store 108 may continually store the newly received server console data 112 as buffered server console data 113. This buffered server console data 113 may be sent to various entities including entities that request the buffered data such as entity 115. The entity may be a user, an institution, a computer system, an application or service or other type of entity. Indeed, in some cases, the entity may be a chassis management application.

In some embodiments, the polling module 106 will begin polling the server console 110 upon receiving an indication to begin polling for server console data. This indication may come from an entity (e.g. 115) or from another user or application. Once the server console 110 begins sending server console data 112, the buffering module 107 may buffer this data in a data store. The buffered console data 113 may be encapsulated into a standardized response message prior to being provided to the specified entity. Thus, in some cases, the server console data received at the buffering module 107 may be encapsulated into a standardized response message (e.g. an Intelligent Platform Management Interface (IPMI) message) prior to being stored in the data store. In other cases, the data may be stored as it is received, and later encapsulated into a standardized response message prior to being transmitted to the entity 115 or other destination. In some embodiments, the buffered server console data 113 may be encapsulated into some type of standardized form on demand, as requests 114 from the entity are received.

The baseboard management controller 105, as described above, may be configured to read and buffer serial console output. Thus, BMC 105 may receive serial console data 112, read the data and buffer it in data store 108. The BMC itself may be any type of hardware controller including a traditional hardware processor. As mentioned above, the buffered serial console data 113 may be transferred to an entity in an encapsulated (e.g. standardized) form. The BMC may then receive encapsulated data from a chassis management application (e.g. entity 115), and unencapsulate the received encapsulated data. Once the data has been unencapsulated, it may then be sent to the server serial console 110.

In some cases, server console data may be received from the server console 110 and buffered server console data may be provided to the specified entity 115 simultaneously. In this manner, the polling module 109 may be continually polling and eliciting server console data 112 from the server console 110. This data may be received at the BMC at the same time that at least a portion of previously buffered server console data 113 is being provided to the entity 115. Accordingly, a server serial console 110 may receive poll requests, and provide console data, while the BMC 105 is buffering that data and providing it to a requesting entity 115 simultaneously. This can be done without suspending commands to other server blades or other computing systems, and without halting internal blade polling or increasing fan speed to compensate for temperature excursions.

In some embodiments, the BMC may implement multiple different processors or processing cores. The BMC may use these multiple processors or processing cores to process received server console data with one processor or thread, while providing buffered console data 113 to the entity 115 with another thread or processor. In this manner, the receiving process and the distribution process avoid processor-related bottlenecks by assigning different processors or cores to the various BMC tasks. Still further, when the processors or cores are polling and receiving data from the server serial console 110, the polling may be performed according to a timeout parameter that automatically stops polling if no receive or send data commands have been provided within a specified time frame. For example, as described above with relation to FIG. 5, if no ReceiveSerialData or SendSerialData commands are received for a certain period of time, the polling module 106 may automatically terminate polling until a new receive or send data command is received. Thus, the BMC may poll and receive serial console data, and buffer and provide that data to requesting parties at the same time (or substantially at the same time).

Turning now to FIG. 3, a flowchart is illustrated of a method 300 for providing multiple synchronous serial console sessions using data buffering. The method 300 will now be described with frequent reference to the components and data of environment 400 of FIG. 4.

Method 300 includes an act of receiving a first request for serial console data at a chassis management application or remote host, the chassis management application or remote host being configured to conduct a plurality of serial console sessions simultaneously by buffering data received from a serial console (act 310). For example, a chassis management application or remote host 411 may receive first data request 405A from a user, application, service or other computer system. The request may identify specific serial console data that is to be provided by the serial console 409. The chassis management application or remote host 411 may be configured to operate and manage multiple serial console sessions simultaneously by buffering the serial console data in data store 403. For instance, the chassis management application or remote host may establish a first serial console session 408A which includes requests for data 406A and received serial console data 407A. Indeed, method 300 includes an act of the chassis management application or remote host initiating a first serial session between a BMC (e.g. 401) and the serial console 409, the first serial session comprising data requests 406A and responses 407A sent between the BMC 401 and the serial console 409, the BMC storing each serial console response in a data store 403 (act 320).

Method 300 next includes an act of the chassis management application or remote host 411 initiating a second serial session between the BMC and the serial console (act 330) and an act of the chassis management application or remote host simultaneously initiating a second serial session between the BMC and another serial console, the second serial session comprising data requests and responses sent between the BMC and the second serial console, the BMC storing each serial console response in the data store (act 340). For example, the BMC may receive a second data request 405B from another user, application, service or computer system. The second request may specify other serial console data that is to be provided by the serial console 409. The request processing module 410A of the serial server console 409A may process the received data request 406A, and respond to that request by sending serial console data 407A. Similarly, the request processing module 410B of the serial console 409B may process the received data request 406B, and respond to that request by sending serial console data 407B. The serial console data 407A may be sent as part of a first serial console session 408A established between the BMC 401 and the serial server console 409A, and the serial console data 407B may be sent as part of a second serial console session 408B established between the BMC 401 and a different serial server console 409B. The BMC may maintain both of these sessions (or multiple sessions) simultaneously by buffering the received serial console data.

Accordingly, the buffering module 402 of the BMC 401 may buffer the received serial console data in data store 403. As above, the data store may be local to or external to the BMC 401, and may be a singular storage device or may be multiple arrays or networks of storage devices. The data store 403 may store the buffered serial data from the first session 404A as well as the buffered serial data from the second session 404B. In some cases, the first serial session 408A may remain open until a specified timeout time has been reached. This timeout time may be specified by an administrator or by some other user or application. Similarly, the data store may continue to store serial console data until a specified amount of serial console data has been stored, or until it has been buffered for a specified amount of time. Once the buffered data has reached a specified amount or has been buffered for a specified amount of time, any serial console data beyond that amount may be purged from the data store.

As with the serial console data described above in relation to FIG. 1, the buffered serial console data 404A/404B from the respective serial console sessions may be encapsulating using a specified data wrapper. In some cases, this data wrapper may be an Intelligent Platform Management Interface (IPMI) wrapper or some other type of data wrapper. The IPMI data wrapper may standardize the contents of the serial console data to make it more readily available and understandable by other applications or users. This encapsulated serial console response data may be sent to a chassis management software application or other entity. The BMC may use the serial console data to switch between different server computing systems such as blades by reading and interpreting the buffered console data. Once the data has been interpreted, the BMC can identify console sessions and switch between them to communicate with other server blades. Accordingly, by buffering serial console data, chassis management applications and other entities may be able to monitor the health of multiple server blades (or racks of blades) by having the BMC perform data buffering for each of the established serial console sessions.

Accordingly, methods, systems and computer program products are provided which provide synchronous communication between a baseboard management controller (BMC) and a serial console using data buffering. Moreover, methods, systems and computer program products are provided which provide multiple synchronous serial console sessions using data buffering.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. At a computer system including at least one processor, a computer-implemented method for providing synchronous communication between a baseboard management controller (BMC) and a serial console using data buffering, the method comprising:
an act of polling a server console for server console data;
an act of receiving one or more portions of server console data from the server console;
an act of buffering at least a portion of the received server console data in a data store;
an act of receiving a request for at least a specified portion of the buffered server console data from a specified entity; and
an act of providing the requested portion of buffered server console data to the specified entity.

2. The method of claim 1, further comprising an act of receiving an indication to begin polling for server console data.

3. The method of claim 1, wherein the specified entity comprises a chassis management application.

4. The method of claim 1, wherein the buffered console data is encapsulated into a standardized response message prior to being provided to the specified entity.

5. The method of claim 4, wherein the buffered console data is encapsulated into an Intelligent Platform Management Interface (IPMI) response message.

6. The method of claim 1, wherein the at least one processor comprises a baseboard management controller (BMC).

7. The method of claim 6, further comprising:
an act of receiving encapsulated data at the BMC from a chassis management application;
an act of unencapsulating the received encapsulated data; and
an act of sending the unencapsulated data to the server serial console.

8. The method of claim 1, wherein server console data is received from the server console and the buffered server console data is provided to the specified entity simultaneously.

9. The method of claim 8, wherein receiving server console data is performed by first processing thread, and wherein providing the buffered console data is performed by a second, different processing thread.

10. The method of claim 1, wherein polling the server console for server console data is performed according to a timeout parameter that automatically stops polling if no receive or send data commands have been provided within a specified time frame.

11. At a computer system including at least one processor, a computer-implemented method for providing multiple synchronous serial console sessions using data buffering, the method comprising:
an act of receiving a first request for serial console data at a chassis management application or remote host, the chassis management application or remote host being configured to conduct a plurality of serial console sessions simultaneously by buffering data received from a serial console;
an act of the chassis management application or remote host initiating a first serial session between a baseboard management controller (BMC) and the serial console, the first serial session comprising data requests and responses sent between the BMC and the serial console, the BMC storing each serial console response in a data store;
an act of the chassis management application or remote host initiating a second serial session between the BMC and the serial console; and
an act of the chassis management application or remote host simultaneously managing the first serial session and the second serial session between the BMC and a second serial console, the second serial session comprising data requests and responses sent between the BMC and the second serial console, the BMC storing each serial console response in the data store.

12. The method of claim 11, wherein the first serial session remains open until a specified timeout time has been reached.

13. The method of claim 11, wherein the data store continues to store serial console data until a specified amount of serial console data has been stored.

14. The method of claim 13, further comprising an act of purging serial console data that is determined to be beyond the specified amount.

15. The method of claim 11, further comprising:
an act of encapsulating the stored serial console responses in a specified data wrapper; and
an act of sending the encapsulated serial console responses to a chassis management software application.

16. The method of claim 15, wherein the specified data wrapper comprises an Intelligent Platform Management Interface (IPMI) wrapper.

17. A computer system comprising the following:
one or more processors, at least one of which comprising a baseboard management controller (BMC);
one or more computer-readable storage media having stored thereon computer-executable instructions that, when executed by the one or more processors, cause the computing system to perform a method for providing synchronous communication using data buffering, the method comprising the following:
an act of polling a server console for server console data;
an act of receiving one or more portions of server console data from a server console;
an act of buffering the received console data in a data store;
an act of receiving a request for the buffered console data from a specified entity;
an act of providing the buffered console data to the specified entity
an act of receiving encapsulated data at the BMC from a chassis management application;
an act of unencapsulating the received encapsulated data; and
an act of sending the unencapsulated data to the server serial console.

18. The computer system of claim 17, wherein the buffered console data is encapsulated into an Intelligent Platform Management Interface (IPMI) response message.

19. The computer system of claim 17, further comprising switching between different server computing systems by reading and interpreting the buffered console data.

20. The computer system of claim 19, wherein the different computing server computing systems comprise server blades.
